(19) United States
(12) Patent Application Publication
(10) Pub. No.: US 2007/0205895 A1
(43) Pub. Date: Sep. 6, 2007

(54) Pick pocket protection, theft prevention system, and child protection system

(76) Inventor: John H. Bergener, Colonie, NY (US)

Correspondence Address: John H Bergener, 4 Southern Drive, Latham, NY, 12110, US

(21) Appl. No.: 11/529,926

(22) Filed: Sep. 30, 2006

Related U.S. Application Data
(60) Provisional application No. 60/779,611, filed on Mar. 6, 2006.

(51) Int. Cl. G08B 13/14; G08B 21/00; G08B 1/08

(52) U.S. Cl. 340/572.1; 340/686.6; 340/539.15

(57) ABSTRACT

This system uses a radio frequency tag(s) and a two-way polling device to sound an alarm if a wallet is being picked from a pocket or purse. This system can also be used to prevent some other types of theft. The system can also be used to sound an alarm when a child or other person wanders too far away from a parent or guardian.

### EMBODIMENTS

A system which when used will help prevent items from being stolen. The system consists of at least one radio frequency tag(s), or other device that can be polled, hereafter referred to as tag(s). The second part is a two-way polling device or interrogator hereafter referred to as a two-way polling device. The two-way polling device will have a speaker, and a computer chip, which is attached to the item. The two-way polling device polls the tag(s) at regular intervals, measuring either the distance from the tag(s), or the signal strength.

The two-way polling device can determine whether or not it is in proximity to the radio frequency tags(s), or other device, which can be polled. When two-way polling device, detects that the distance is greater then a preset limit, or the signal strength from the tag(s) has fallen below a preset limit; the two-way polling device's speaker loudly announces wallet stolen in several languages, or another alarm sound or phrases. Bringing the protected item within a preset reset distance of one of the radio frequency tags or turning the system off can only reset it.

The two-way polling device can determine the distance from tag(s) by measuring the time it takes to poll transmission to be received back. Alternately the distance can be measured by the strength of the returned signal.

Version 1: The two-way polling device may be attached to a wallet, or built into a wallet. The tag(s) may be worn on one's person over the neck or elsewhere. It can be worn under ones clothes. The preset distance for this example could be a meter. The preset reset distance for this example could be 3 cm. Other distances could of course be used.

Version 2: The tag(s) may be attached to a sign (such as a campaign lawn sign) and the two-way polling device can be used to try and locate the sign if stolen. In this version the polling device would only poll when a switch is turned on. And the alarm would sound when the tag is within a preset, but adjustable distance.

Version 3: The two-way polling device may be attached to a motor vehicle, snowmobile, or boat. The tag(s) may be placed inside a person's home or office or kept with the person. The preset distance for this example could be 50 meters. The preset reset distance for this example could be a meter. Other distances could of course be used. This could reduce the number of false alarms for car theft where current art just sets off the alarm when the vehicle is touched.

Version 4: The two-way polling device may be attached to a bicycle, or other human power vehicle. The tag(s) may be placed inside a person's home, office, or kept with the person. The preset distance for this example could be 50 meters. The preset reset distance for this example could be a meter. Other distances could of course be used.

Version 5: The two-way polling device could be placed on a park bench, or other property in a park, or that is kept outdoors on public or private lands, that can be removed. If protected property were moved more than a preset distance the alarm would go off. The two-way-polling could be set up with different preset distances when protecting more than one item of property. The preset distance could be specific for each item of property

Version 6: A parent, guardian or babysitter could keep the two-way polling device and the tag(s) could be attached to a child's or other person's clothes. The alarm would sound whenever the child or other person gets too far away.

### DIAGRAMS (FIGURES)

FIG. 1. Shows person using Version 1 of this patent application. When the person is carrying both the Tag and the two-way polling device. When the tag and the item attached to the two-way polling device are close together, within the zone of protection, all is quiet. When the item is moved outside the zone of protection the alarm sounds.

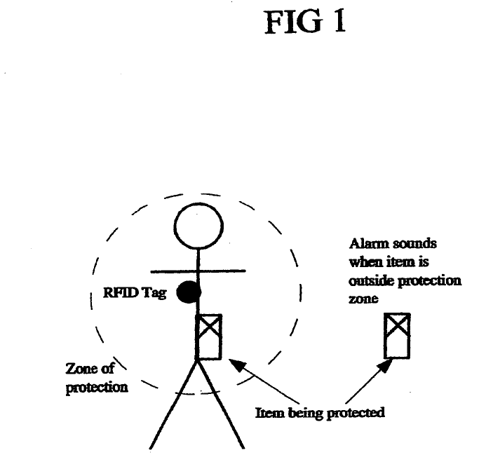

FIG. 2. Shows one example Version 3, 4 or 5 of this patent application. The tag(s) are placed in a fixed location. When the item and the two-way polling is within the zone of protection all is quiet. When the item with the tag travels outside the zone of protection the alarm sounds.

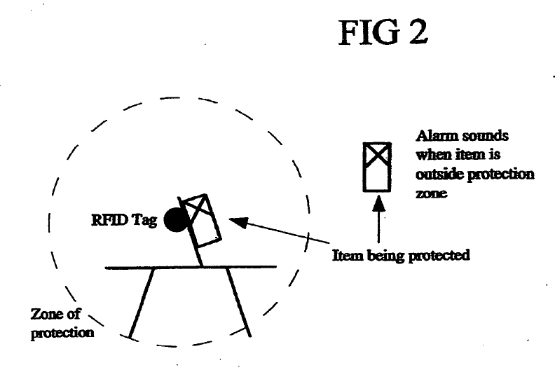

FIG. 3. Shows an overhead view of Versions 1, 3, 4, 5, and 6. When the tag(s) are within the Critical distance boundary (zone of protection) the Interrogator (two-way polling device) is silent. When the Interrogator (two-way polling device) is moved outside the Critical distance boundary (zone of protection) it's alarm goes off.

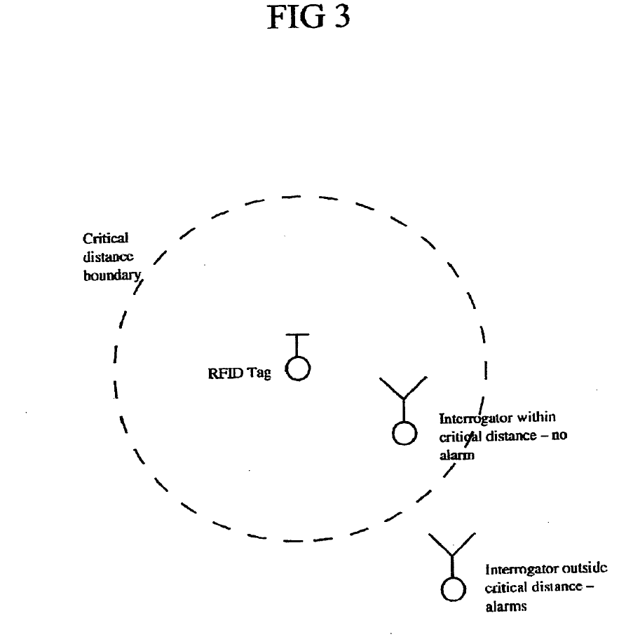

Diagrams (Figures) are included with the original patent application Ser. No. 11/529,926

1) A system that produces an alarm consisting of radio frequency tag(s) or other device that can be polled and a two-polling device with speaker and computer chip. It can be attached to straps so they can be worn around the neck, under a persons clothing. Alternately they can be attached, or worn in other places if a person wishes. There can be two radio frequency tags, so that a person's own body does not block the signal. The two-way polling device is designed so it can be attached to, or built into the wallet or any other item a person wishes to protect, with a pin or any other type of fastener.

2) The two-way polling device can be included in wallets or other items, at the time of their manufacture or added later.

3) An alternate use is having the two-way polling device on the person and a radio frequency tag(s) attached or with the item to be protected.

4) An alternate method could be have the two polling device go off whenever the radio frequency tag(s) are within a preset limit of the two polling device. This would allow location of a stolen property. The tag(s) could be placed in a radio signal proof bag when not being used.

5) The two-way polling device can be battery powered and/or powered by rechargeable power system, or powered by being plugged in to the electric grid.

6) For versions 3, 4, and 5 an additional two-way polling device could also be kept in the home, office, or with a person, so that the alarm would sound both in the vehicle and in the home, office, or near the person.

7) Alternately for version 5, the tag(s) could be placed on the protected item, and the two-way polling device kept in the office, or other location.

8) Alternately the two-way polling device could poll differently coded tags. The two-way polling device could do a different type of alarm sound or message, or phrase for each tag it is polling. Allowing one location or person to keep track of property and to know what had been taken.

9) Alternately for version 6, a parent, guardian or babysitter could keep the tag(s) and the two-way polling device could be attached to a child's clothes. The alarm would sound whenever the child gets too far away.

10) A system for alerting a person when his wallet is moved beyond a fixed radius from the person's body.
